(19) United States
(12) Patent Application Publication
(10) Pub. No.: US 2024/0013330 A1
(43) Pub. Date: Jan. 11, 2024

(54) METHOD OF CHOOSING A CAREER

(71) Applicant: Michael O'Connor, Peoria, AZ (US)

(72) Inventor: Michael O'Connor, Peoria, AZ (US)

(21) Appl. No.: 17/857,208

(22) Filed: Jul. 5, 2022

(51) Int. Cl. G06Q 50/20; G06Q 10/10

(52) U.S. Cl. CPC G06Q 50/2057; G06Q 10/10

(57) ABSTRACT

A method of choosing a career including providing a computer system programmed to accept and process information and career preferences inputted by a current and future career seeker, and to provide a list of career choices based on their information and career preferences. The method further includes having the current and future career seeker experience the work and working environment of their career choices and input their feedback and rating of those career choices into the computer system for evaluation by the computer system. The computer system is further adapted to reevaluate and modify the list of career choices presented to the current and future career seeker based upon their feedback and ratings.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to methods for aiding current and future career seekers when choosing a career and career paths.

### 2. Description of the Related Art

Prior art methods for aiding current and future career seekers when choosing a career and career paths usually include computer systems that provide a list of career choices based on information and career preferences inputted by a current and future career seeker. However, current and future career seekers usually have no idea what the careers they are interested in are like in real life, so when they enter that field and start actually working they often find many reasons why that they do not like that career. Unfortunately, it is usually too late to change careers without returning to school or returning for alternative training, thereby wasting years of time and resources. Accordingly, the present invention overcomes the disadvantages associated with the prior art, by providing a method of choosing a career that further includes having the current and future career seeker actually experience the work and working environment of their career choices and input their feedback and rating of those career choices into the computer system for evaluation by the computer system. The computer system would then reevaluate and modify the list of career choices presented to the current and future career seeker based upon their feedback and ratings. As such, the current and future career seeker would be able to enter a career with a much higher chance of success and happiness.

### BRIEF SUMMARY OF THE INVENTION

In view of the foregoing disadvantages inherent in the known types of career choice methods or the like in the prior art, the present invention provides an improved method of choosing a career. As such, the general purpose of the present invention, which will be described subsequently in greater detail, is to provide a method of choosing a career, with all the advantages of the prior art and none of the disadvantages, that provides a computer system programmed to accept and process information and career preferences inputted by a current and future career seeker, and provides a list of career choices based on their information and career preferences. The method further includes having the current and future career seeker experience the work and working environment of their career choices and input their feedback and rating of those career choices into the computer system for evaluation by the computer system. The computer system is further adapted to reevaluate and modify the list of career choices presented to the current and future career seeker based upon their feedback and ratings.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a flow chart of the method of choosing a career according to an embodiment of the present invention.

FIG. 2 shows a flow chart of the method of choosing a career according to the preferred embodiment of the present invention.

FIG. 3 shows a perspective view of the computers and telecommunication system for the method of choosing a career according to the preferred embodiment of the present invention of FIG. 2.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

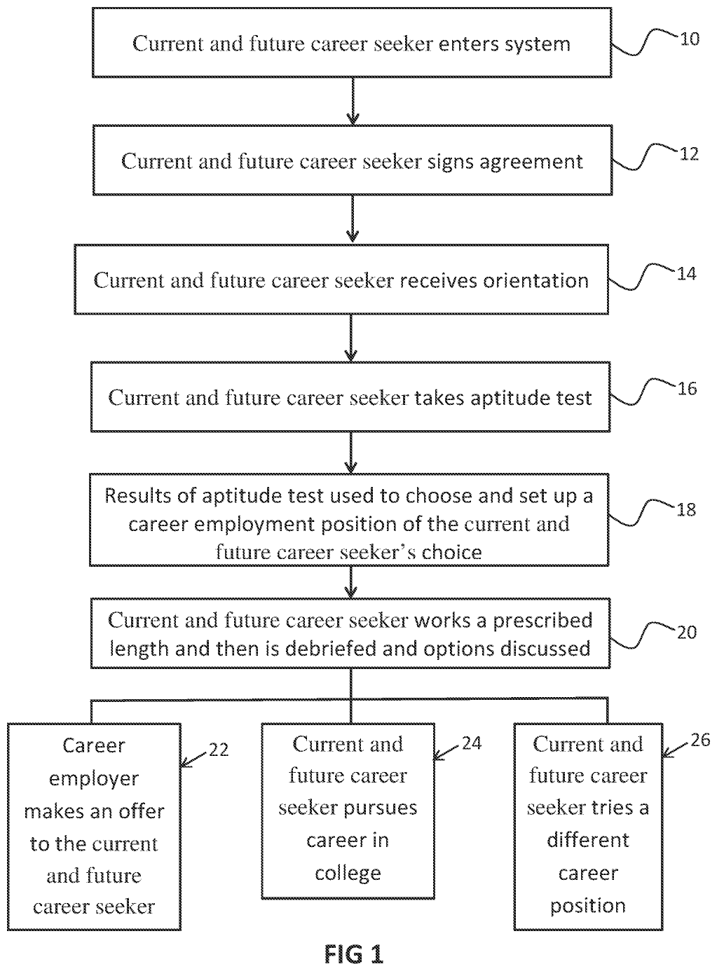

As shown in the flowchart of FIG. 1, a current and future career seeker enters the system 10 when nearing the end of their high school career, signs an agreement 12, receives an orientation 14, and takes an aptitude test 16. The results of the aptitude test are then used to choose and set up a career employment position of the current and future career seeker's choice 18. Once the current and future career seeker has worked for the prescribed length the current and future career seeker is debriefed and options are discussed 20. One option is for the career employer to make an offer to the current and future career seeker 22. Another option is for the current and future career seeker to pursue that career in college 24. A third option is for the current and future career seeker to try a different career position and start the process over again 26.

Part of the system may include the current and future career seeker receiving automated emails, SMS messages, electronic calendar reminders, and phone call reminders to assist the current and future career seeker during the process.

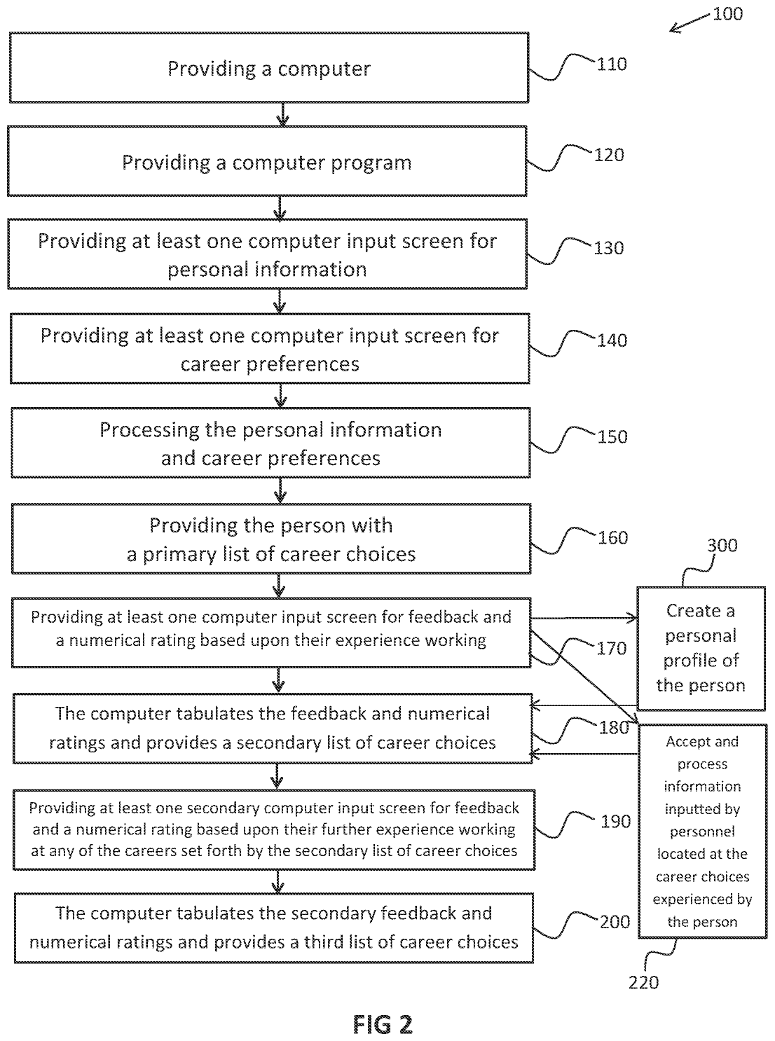

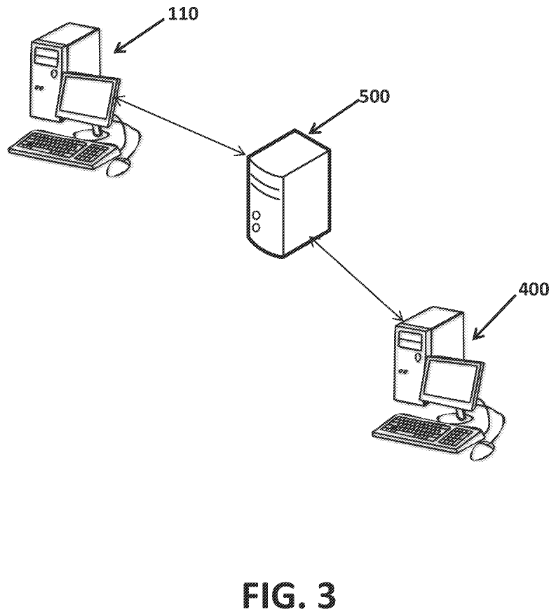

In the preferred embodiment, as shown in FIGS. 2 and 3, the present invention discloses a method of choosing a career 100 comprising the steps of providing a computer 110 adapted to allow a person to input information into a computer program; providing a computer program 120 programmed onto the computer that is adapted to accept and process the information inputted by the person, wherein the computer program is adapted to receive and store information pertaining to a plurality of careers, and wherein the computer program 120 includes the steps of providing at least one input screen 130 upon the computer that is adapted to allow the person to input personal information into the computer program; providing at least one input screen 140 upon the computer that is adapted to allow the person to input career preferences; processing the personal information and the career preferences 150; providing the person with a primary list of career choices 160 based on the personal information and the career preferences; providing at least one input screen 170 upon the computer that is adapted to allow the person to input feedback and a numerical rating based upon their experience working at any of the careers set forth by the list of career choices, wherein the computer program is adapted to tabulate the feedback and numerical ratings and provide a secondary list of career choices 180 to the person based upon the feedback and numerical ratings.

The computer program 120 is further adapted to provide at least one secondary input screen 190 adapted to allow the person to input secondary feedback and a numerical ratings based upon their further experience working at any of the careers set forth by the secondary list of career choices 180, which may also allow the person to input feedback based upon work hours, working conditions, task difficulties, commuting time, and company personnel interactions. Furthermore, the computer program 120 is adapted to tabulate the secondary feedback and numerical ratings and provide a third list of career choices 200 to the person based upon the secondary feedback and numerical ratings.

The computer program 120 is further adapted to create a personal profile 300 of the person based upon the personal information, the career preferences, and the feedback and numerical ratings, wherein the personal profile is adapted to be used to aid in identifying and presenting secondary career choices 180 to the person.

The computer program 120 may further be adapted to accept and process information inputted by personnel 220 located at the career choices experienced by the person, and wherein that information is adapted to be used by the computer program to aid in identifying and presenting secondary career choices 180 to the person.

The method of choosing a career 100 may further comprise the steps of providing at least one secondary computer 400 located remotely from the computer 110 and adapted to electronically communicate with the computer; and wherein the at least one secondary computer 400 is adapted to allow the personnel located at the career choices to send information to the computer; and providing a telecommunication system 500 adapted to facilitate communication between the computer 110 and the at least one secondary computer 400.

The numerical ratings may be formed as a rating between 1 and 10, wherein 1 is the poorest rating and 10 is the best rating. The ratings may also be formed as a choice between 1 and 5 stars, wherein 1 is the poorest rating and 5 is the best rating. Furthermore, the ratings may also be formed as a choice between statements that best describe their work experience. The ratings may also be formed as other known ratings systems, or similar types of ratings systems.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A method of choosing a career comprising the steps of:
providing a computer;
wherein said computer is adapted to allow a person to input information into a computer program;
providing said computer program;
wherein said computer program is programmed onto said computer and is adapted to accept and process said information inputted by said person:
wherein said computer program is adapted to receive and store information pertaining to a plurality of careers;
and wherein said computer program includes the steps of:
providing at least one input screen upon said computer that is adapted to allow said person to input personal information into said computer program;
providing at least one input screen upon said computer that is adapted to allow said person to input career preferences;
processing said personal information and said career preferences;
providing said person with a primary list of career choices based on said personal information and said career preferences;
providing at least one input screen upon said computer that is adapted to allow said person to input feedback and a numerical rating based upon their experience working at any of said careers set forth by said list of career choices;
wherein said computer program is adapted to tabulate said feedback and numerical ratings and provide a secondary list of career choices to said person based upon said feedback and numerical ratings.

2. The method of choosing a career of claim 1, wherein said computer program is further adapted to provide at least one secondary input screen adapted to allow said person to input secondary feedback and a numerical ratings based upon their further experience working at any of said careers set forth by said secondary list of career choices; and wherein said computer program is adapted to tabulate said secondary feedback and numerical ratings and provide a third list of career choices to said person based upon said secondary feedback and numerical ratings.

3. The method of choosing a career of claim 1, wherein said numerical rating is formed as a rating between 1 and 10, wherein 1 is the poorest rating and 10 is the best rating.

4. The method of choosing a career of claim 1, wherein said computer program is further adapted to create a personal profile of said person based upon said personal information, said career preferences, and said feedback and numerical ratings; and wherein said personal profile is adapted to be used to aid in identifying and presenting secondary career choices to said person.

5. The method of choosing a career of claim 1, wherein said at least one input screen is adapted to allow said person to input feedback based upon work hours, working conditions, task difficulties, commuting time, and company personnel interactions.

6. The method of choosing a career of claim 1, wherein said computer program is further adapted to accept and process information inputted by personnel located at said career choices experienced by said person; and wherein said information inputted by said personnel is adapted to be used by said computer program to aid in identifying and presenting secondary career choices to said person.

7. The method of choosing a career of claim 6, further comprising the steps of:
providing at least one secondary computer:
wherein said at least one secondary computer is located remotely from said computer and is adapted to electronically communicate with said computer; and
wherein said at least one secondary computer is adapted to allow said personnel located at said career choices to send information to said computer; and
providing a telecommunication system;
wherein said telecommunication system is adapted to facilitate communication between said computer and said at least one secondary computer.
